(19) United States
(12) Patent Application Publication
(10) Pub. No.: US 2015/0092985 A1
(43) Pub. Date: Apr. 2, 2015

(54) UPDATING FILTER PARAMETERS OF A SYSTEM

(71) Applicant: QUALCOMM Incorporated, San Diego, CA (US)

(72) Inventors: Mahesh RAMACHANDRAN, San Jose, CA (US); Arvind RAMANANDAN, San Diego, CA (US); Christopher BRUNNER, San Diego, CA (US); Abhishek TYAGI, San Diego, CA (US); Murali Ramaswamy CHARI, San Diego, CA (US); Mingyang LI, Riverside, CA (US)

(21) Appl. No.: 14/497,135

(22) Filed: Sep. 25, 2014

Related U.S. Application Data
(60) Provisional application No. 61/884,847, filed on Sep. 30, 2013.

(51) Int. Cl. G06T 7/20

(52) U.S. Cl. CPC G06T 7/208; G06T 7/2033; G06T 2207/10016; G06T 2207/10004
USPC 382/103

(57) ABSTRACT

Techniques are disclosed for estimating one or more parameters in a system. A device obtains measurements corresponding to a first set of features and a second set of features. The device estimates the parameters using an extended Kalman filter based on the measurements corresponding to the first set of features and the second set of features. The measurements corresponding to the first set of features are used to update the one or more parameters, and information corresponding to the first set of features. The measurements corresponding to the second set of features are used to update the parameters and uncertainty corresponding to the parameter. In on example, information corresponding to the second set of features is not updated during the estimating. Moreover, the parameters are estimated without projecting the information corresponding to the second set of features into a null-space.

### CROSS-REFERENCE TO RELATED APPLICATIONS

This application claims the benefit of U.S. Provisional Application No. 61/884,847 entitled “Batch Update,” filed Sep. 30, 2013, which is assigned to the assignee of the present application and hereby expressly incorporated by reference.

### FIELD OF THE DISCLOSURE

Aspects of the disclosure relate to estimating a parameter corresponding to a device, and more particularly to using a modified extended Kalman filter for estimation.

### BACKGROUND

Augmented Reality (AR) provides a view of a real-world environment that is augmented with computer-generated audio and/or visual content. The audio and/or visual content can be overlaid over or integrated into an image or video of the real-world environment captured using a camera of a mobile device, or displayed on a transparent or semi-transparent screen through which a user is viewing the real-world environment. For example, an augmented reality application may be implemented on a mobile phone or tablet computer that includes a camera that can be used to capture images or video of a view of the real-world environment and a display that can be used to display an augmented view of the real-world environment, and/or on a head-mounted display (HMD). The device can include one or more sensors that collect data which can be used to determine position, speed, and/or direction of movement of the device. This information can be used to assist the device in generating augmentation content. The sensors can also be used to collect input information from a user, such as touchscreen selections or other input information that can be used to allow the user to navigate the augmented content displayed on the device.

Several methods exist in the art for estimating parameters of a system. For example, Extended Kalman Filter (EKF) may be used to the estimate position of a device. However, the computational complexity of EKF may grow rapidly with increased accuracy of estimation.

### SUMMARY

A method for estimating one or more parameters of a system is disclosed. The method generally includes, in part, obtaining measurements corresponding to a first set of features and a second set of features, and estimating the one or more parameters using an extended Kalman filter (EKF) based on the measurements corresponding to the first and the second set of features. The measurements corresponding to the first set of features are used to update the parameter and information corresponding to the first set of features. The measurements corresponding to the second set of features are used to update the one or more parameters and uncertainty corresponding to the one or more parameters. The information corresponding to the second set of features is not updated during estimation. In one example, the one or more parameters are estimated without projecting the information corresponding to the second set of features into a null-space.

An apparatus for estimating one or more parameters of a system is disclosed. The apparatus includes at least one processor and a memory coupled to the at least one processor. The at least one processor is generally configured to, in part, obtain measurements corresponding to a first set of features and a second set of features, and estimate the one or more parameters using an extended Kalman filter (EKF) based on the measurements corresponding to the first set of features and the second set of features. The measurements corresponding to the first set of features are used to update the one or more parameters. In addition, information corresponding to the first set of features and the measurements corresponding to the second set of features are used to update the one or more parameters and uncertainty corresponding to the one or more parameter. The information corresponding to the second set of features is not updated during the estimating. In addition, the one or more parameters are estimated without projecting the information corresponding to the second set of features into a null-space.

An apparatus for estimating one or more parameters of a system is disclosed. The apparatus generally includes, in part, means for obtaining measurements corresponding to a first set of features and a second set of features, and means for estimating the one or more parameters using an extended Kalman filter (EKF) based on the measurements corresponding to the first set of features and the second set of features. The measurements corresponding to the first set of features are used to update the one or more parameters, and information corresponding to the first set of features and the measurements corresponding to the second set of features are used to update the one or more parameters and uncertainty corresponding to the one or more parameter. The information corresponding to the second set of features is not updated during the estimating. In addition, the one or more parameters are estimated without projecting the information corresponding to the second set of features into a null-space.

A non-transitory computer readable medium for estimating one or more parameters corresponding to a device is disclosed. The non-transitory computer readable medium includes, in part, computer-readable instructions configured to cause a processor to obtain measurements corresponding to a first set of features and a second set of features, and estimate the one or more parameters using an extended Kalman filter (EKF) based on the measurements corresponding to the first set of features and the second set of features. The measurements corresponding to the first set of features are used to update the one or more parameters, and information corresponding to the first set of features and the measurements corresponding to the second set of features are used to update the one or more parameters and uncertainty corresponding to the one or more parameter. The information corresponding to the second set of features is not updated during the estimating. Furthermore, the one or more parameters are estimated without projecting the information corresponding to the second set of features into a null-space.

### BRIEF DESCRIPTION OF THE DRAWINGS

An understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an example scenario in which a user walks in a city while holding his mobile phone.

FIG. 2 illustrates an example flow chart that can be used by a device to estimate one or more parameters, according to one embodiment of the present disclosure.

FIG. 3 illustrates example operations that may be performed by a device for estimating a parameter, in accordance with certain embodiments of the present disclosure.

FIG. 4 illustrates one potential implementation of a device which may be used to estimate a parameter, according to certain embodiments of the present disclosure.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the disclosure.

Certain embodiments of the present disclosure efficiently estimate one or more parameters corresponding to a system using modified Extended Kalman filter (EKF), by using a possibly large number of feature points. A feature point may refer to a point of reference in the environment that can be used in the estimation. For example, position of a mobile device may be estimated by tracking several feature points that are located in a scene surrounding the mobile device. At each time stamp, the device may make measurements corresponding to each feature point and use the new measurements to update positional estimates of the device. For example, the device may measure its distance from each of the feature points at each time stamp. Alternatively or additionally, the device may make any other type of measurements. Using EKF, the device may keep track of its position by updating the estimation with information provided in each measurement for each feature point. As used herein, the term position may refer to three-dimensional coordinates of the device (e.g., along X, Y and Z axes) and rotation along each axis. In another embodiment, the device may keep track of its navigational state (e.g., translation, translational velocity, angular velocity, and the like).

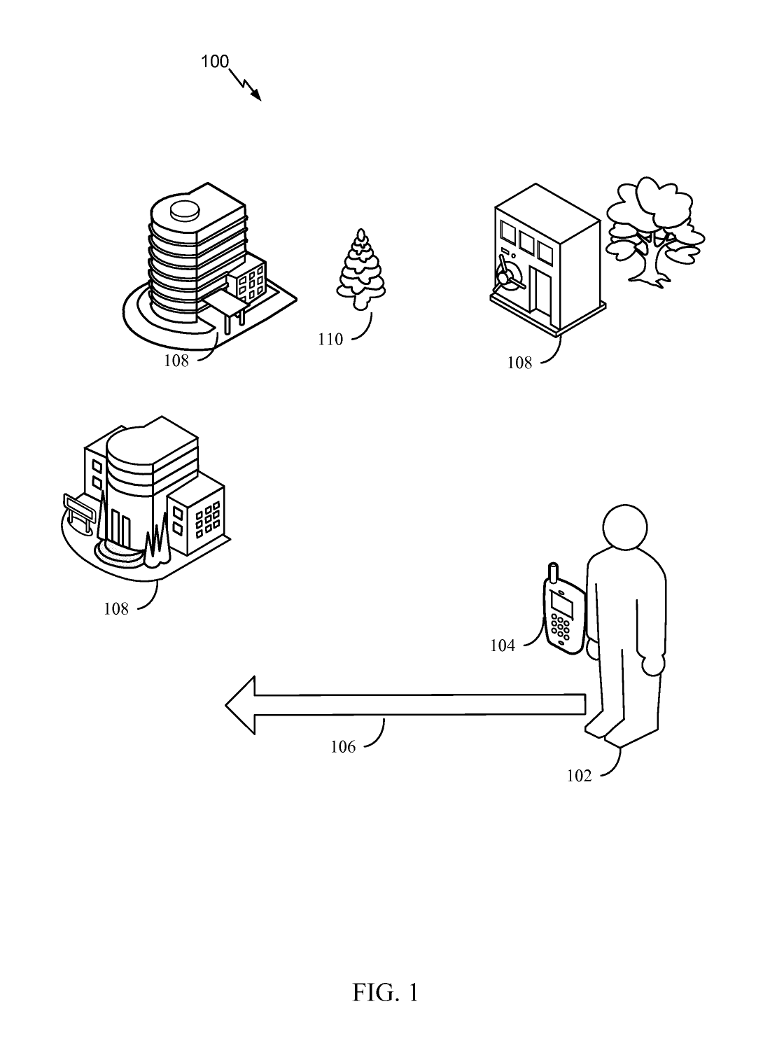

FIG. 1 illustrates an example scenario in which a user walks in the streets of a city while holding his mobile device 104. The user may take several images using the camera in his mobile device 104 while walking in direction 106. In this example, position of the user may be estimated and/or tracked using an estimation method such as EKF based on the captured information. For example, buildings 108 and trees 110 may each be used as feature points in the EKF. Increasing number of feature points used in the estimation increases accuracy of the estimation. However, the number of computations that can be carried out places a limit on the number of feature points that in practice can be used in the estimation. Since mobile devices are limited in terms of their processing capabilities, only a limited number of feature points is usually used in the estimation.

Certain embodiments of the present disclosure estimate one or more parameters corresponding to a system using a relatively large number of feature points without any increase (or a minimal increase) in processing. The proposed method may be used in any system that estimates one or more parameters based on measurements that are performed in a sequence of time stamps. Although the present disclosure refers to estimating position of a device as an example, the proposed estimation method may be used for estimating parameters of any system based on a set of measurements. Computer Vision applications are one of the numerous applications for the estimation method as presented herein.

The term Computer Vision application as used herein refers to a class of applications related to the acquisition, processing, analyzing, and understanding of images. CV applications include, without limitation, mapping, modeling—including 3-D modeling, navigation, augmented reality applications, and various other applications where images acquired from an image sensor are processed to build maps, models, and/or to derive/represent structural information about the environment from the captured images.

Simultaneous localization and mapping (SLAM) is one of the algorithms used in CV that is concerned with the problem of building a map of an unknown environment by mobile device while at the same time navigating the environment using the map. SLAM may consist of different part such as landmark or feature point extraction, data association, state estimation, state update and landmark update. Several methods exist in the art to solve each of these parts.

As used herein, a mobile device, sometimes referred to as a mobile station (MS), may take the form of a cellular phone, mobile phone or other wireless communication device, personal communication system (PCS) device, personal navigation device (PND), Personal Information Manager (PIM), Personal Digital Assistant (PDA), laptop or other suitable mobile device capable of receiving wireless communication and/or navigation signals. The term “mobile device” is also intended to include gaming or other devices that may not be configured to connect to a network or otherwise communicate, either wirelessly or over a wired connection, with another device. Mobile devices also include devices which communicate with a personal navigation device (PND), such as by short-range wireless, infrared, wire line connection, or other. Also, “mobile device” is intended to include all devices, including wireless communication devices, computers, laptops, etc. which are capable of communication with a server, such as via the Internet, Wi-Fi, or other network. Any operable combination of the above are also considered a “mobile device.” Embodiments disclosed herein may be used in a standalone AR system/device, for example, in a mobile device that does not require communication with another device.

Extended Kalman filter (EKF) is one of the methods used in SLAM to estimate/update position of a device based on multiple feature points in the environment. The EKF is usually described in terms of state estimation. The EKF keeps track of an estimation of a state (e.g., position) of the device and the uncertainty in the estimated state, in addition to the uncertainty in each of the feature points used in the estimation. For example as illustrated in FIG. 1, the mobile device 104 captures consecutive images from its environment using its camera. These images may have some overlap with each other. Multiple points in these images, such as the building 108 and tree 110 may be selected as feature points and be tracked in different images.

In general, the mobile device may select a few of the feature points among all of the possible feature points to use and track in the estimation procedure. Each feature point that is tracked increases the amount of processing at every iteration of the estimation/update procedure. Therefore, traditionally, only a limited number of the feature points are selected from a set of possible feature points to be used in the estimation.

Usually, the feature points that are suitable candidates for tracking and/or estimation process are tracked through the image sequence. A three dimensional (3D) location estimate of these feature points are maintained in the state vector of the system. Therefore, these feature points are called “in state feature.” The in-state features are the feature points that can easily be observed and distinguished from the environment. Moreover, the in-state features should be re-observed by the device for at least some duration of time. For example, the transitory feature points that are visible by a sensor (e.g., the camera) for only a short amount of time are not good candidates to be used as in-state features. In the example shown in FIG. 1, a bird sitting on the tree for a short time may not be a good candidate for an in-state feature. Individual in-state features should be easily distinguishable from each other.

As mentioned earlier, some feature points in the environment may not be suitable candidates to be used as in-state features, however, these feature points may still have useful information about the system. These feature points are referred to as “out-of-state” features in the rest of this document. Certain embodiments of the present disclosure use one or more of the out-of-state features in addition to the in-state features to update an estimated state of a device (e.g., position, mapping information, and the like), with minimal or no increase in the computations.

Current version of the EKF method known in the art only uses the latest measurement (e.g., at the present time) of each in-state feature to update the current estimate of the state and its uncertainty. The EKF method usually discards each measurement corresponding to the in-state features after they are used to update the state of the system. Certain embodiments use both present and past values of the in-state and/or out-of-state features to update the estimated state (e.g., position) of the device. As a result, in one embodiment, as many features as needed may be used to update the state vector and/or position of the device.

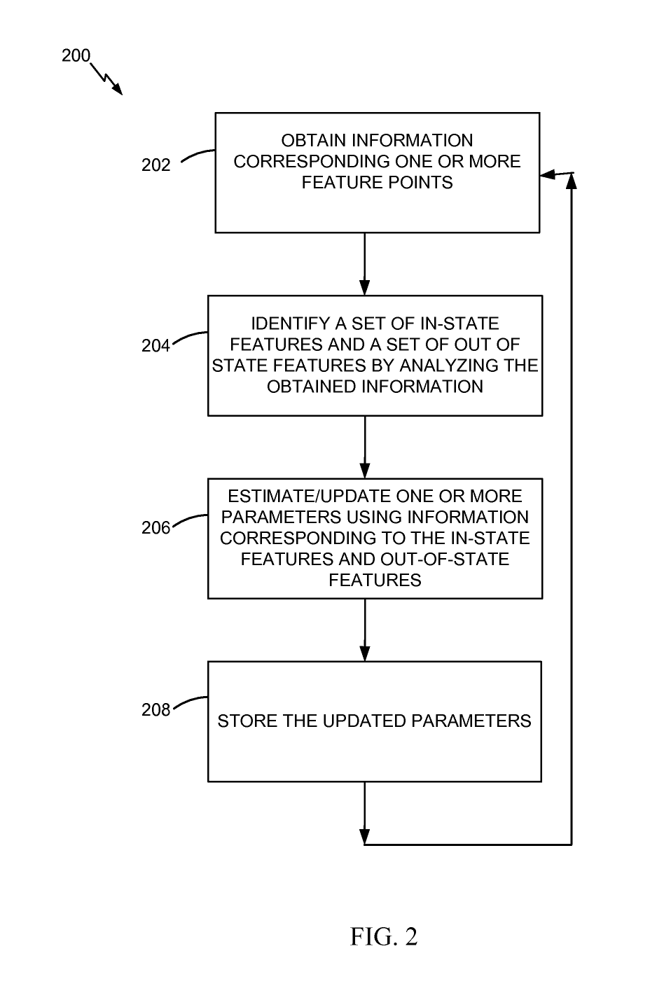

FIG. 2 illustrates an example flow chart that can be used by a device to estimate one or more parameters, according to one embodiment. At 202, the device receives information corresponding to one or more feature points. Alternatively, the device itself measures data corresponding to the one or more feature points. At 204, the device analyzes the data and selects one or more of the feature points to be included in the state vector (e.g., in-state features). In addition, the device may select one or more of the remaining feature points as out-of state feature points. At 206, the device processes the received information to estimate one or more parameters. For example, the device may estimate its position, velocity, or any other parameter based on the information corresponding to the in-state features and out-of-state features. As an example, the device uses EKF to estimate its position using only the in-state features. Alternatively, the device uses the estimation method as described herein to estimate its position using both in state and out of state features. In yet another example, the device uses some of the in-state features and/or some of the out-of-state features to estimate its parameters. At 208, the device stores the estimated parameters.

### Modified Extended Kalman Filter

Let Xε [symbol] ^{N} be a state vector, the estimate \hat{X}(t) of the state vector may be denoted as follows:

\hat{X}(t)· [symbol] (X(t),Pₓ(t)) (1)

At time t, y(t)ε [symbol] ^{m} may represent the measurements corresponding to an out-of-state feature. Let ŷ(t) be an estimate of the measurement y, the innovation δy=y−ŷ (e.g., a difference between the actual value corresponding to the feature and the estimated value of the feature) may be modeled as follows:

δy=H_{X}δX+H_{f}δf+n,

y=h(X,f) (2)

in which f represents the three-dimensional (3-D) feature vector of the Kalman filter,

$$Hx ∈ {ℝ}^{m \times n} = \frac{d h}{d X}$$

represents the Jacobian of function h with respect to the state vector X and

$${H}_{f} ∈ {ℝ}^{m \times 2} = \frac{d h}{d f}$$

represents Jacobian of function h with respect to the feature vector f. In addition, n˜ [symbol] (0, R) represents the measurement noise vector which can be a Gaussian noise with mean equal to zero and variance equal to R. In general, if the estimated value is accurate, the innovation δy will be close to zero.

### Standard EKF Update

An augmented state vector δX_{A}^{T} may be defined as follows:

δX_{A}^{T}=[δX^{T}δf^{T}], (3)

in which δX represents error in the estimate of the state vector X and δf represents the error in the estimate of the feature vector f, and (.)^{T} represents transpose of a matrix.

The covariance of the error in the estimate of the augmented vector may be written as:

$${P}_{A} = [ \begin{matrix}{P}_{X} & {Z}_{2} \\ {Z}_{1} & {P}_{f}\end{matrix} ] \qquad ( 4 )$$

in which each of the matrices Z₁ and Z₂ may have values equal to zero or other than zero.

The measurement Jacobian of the augmented matrix may be written as H_{A}=[H_{X}, H_{f}], such that:

δy=H_{A}δX_{A}+n (5)

The standard EKF update may be given by the following equations:

K=P_{A}H^{T}_{A}(H_{A}P_{A}H_{A}^{T}+R)⁻¹ (6)

P_{A}⁺=(I−KH_{A})P_{A}, and (7)

δ\hat{X}_{A}⁺=Kδy. (8)

Note that K^{T}=[K₁^{T} K₂^{T}], where K₁δ [symbol] ^{N×m}, K₂ε [symbol] ^{3×m}. In addition, the following equations may be written for innovation of the augmented state vector and its covariance P_{A}:

$$\begin{matrix}δ {X}_{A}^{{+}^{T}} = [ δ {X}^{{+}^{T}} δ {f}^{{+}^{T}} ] & ( 9 ) \\ {P}_{A}^{+} = [ \begin{matrix}{P}_{X}^{+} & {P}_{Xf}^{+} \\ {P}_{fX}^{+} & {P}_{f}^{+}\end{matrix} ] , & ( 10 )\end{matrix}$$

where P_{X}⁺ε [symbol] ^{N×N}, P_{Xf}⁺ε [symbol] ^{N×3}, P_{fX}⁺ε [symbol] ^{3×N}, P_{f}⁺ε [symbol] ^{3×3}.

The estimation procedure according to one embodiment does not add the feature points in vector f (e.g., the out-of-state features) to the state vector. As a result, there is no need to calculate δ_{f}⁺^{^{T}}, K₂, P_{Xf}⁺, and P_{f}⁺, as explained further below.

For certain embodiments, the augmented state and the covariance matrix in the estimation method as described herein may be defined as equations (3) and (4), as follows:

$$\begin{matrix}δ {X}_{A}^{T} = [ δ {X}^{T} δ {f}^{T} ] , \\ {P}_{A} = [ \begin{matrix}{P}_{X} & {Z}_{2} \\ {Z}_{1} & {P}_{f}\end{matrix} ] .\end{matrix}$$

Then, the innovation covariance matrix S may be written as follows:

$$\begin{matrix}S = {H}_{A} {P}_{A} {H}_{A}^{T} + R , and & ( 12 ) \\ {P}_{A} = [ \begin{matrix}{P}_{x} & 0 \\ 0 & {P}_{f}\end{matrix} ] , & ( 13 )\end{matrix}$$

Next, the following EKF update rule may be used:

K₁=P_{X}H_{X}^{T}S⁻¹, (14)

[symbol]

_{A}⁺=K₁δy, (15)

P_{A}⁺=(I−K₁H_{A})P_{X}. (16)

Out-of-state features, by virtue of not being in the state, reduce the size of the P matrix. Therefore, computation load reduces because extra elements in P do not need to be processed. As a result, any number of feature points may be used in the system to update the estimated position of the device, with minimal change in the amount of processing. In general, according to one embodiment, as many features as possible may be used to make an update to the state. Furthermore, this method may be used to update the estimates using multiple feature points at a time (e.g., hence the name “batch update”). The method as described herein may improve performance of the system and improve accuracy of the estimation without increasing computational load of the device compared to the original EKF method.

In one embodiment, the device may estimate the position using an extended Kalman filter (EKF) in which a variance value corresponding to each of the out-of-state features is artificially set to a large number.

According to one embodiment, measurement models resulting from “not-in-state” features may be written as follows:

δy=H_{X}δX+H_{f}f+n (19)

where δy represents the measurement residual, δX represents the error in camera trajectory, f represents the error in an estimate of 3D feature vector position, n is measurement noise, and Hₓ and H_{f} are known matrices of suitable dimensions. In general, in order to use δy to correct δX with an EKF, a measurement model with the following form may be defined:

δy₁=H_{X}_{₁}δX+n₁ (20)

where some or all of δy₁, H_{X}_{₁}, and n₁ may be functions of δy, H_{X}, H_{f}, f and n.

Since f is uncorrelated with δX, according to one embodiment, f can be absorbed into noise n without violating any assumptions of the EKF model. It should be noted that if f and δX are correlated, f can still be absorbed into noise n, however, the update steps become very complicated. The update rule for the Batch Update method may be written as follows:

δy=H_{X}δX+(H_{f}f+n) (21)

Comparing equations (20) and (21) results in the following equations:

δy₁=δy,

H_{X}_{₁}=H_{X},

n₁=H_{f}f+n.

It should be noted that the Multi-state constrained Kalman filter (MSCKF) simplifies the calculations by multiplying special matrix V with the equation (19). According to MSCKF, If rank(H_{f})<3, hence there exists a unique matrix Vε [symbol] ^{(m-3)×m} such that rank(V)=m−3 and VH_{f}=0. Therefore, rows of V span the null space of H_{f}. By multiplying V in equation (19) from left side, the following equation is derived:

Vδy=VH_{X}X+Vn (22)

For MSCKF, the standard EKF update can be carried out according to the measurement model in (22). Therefore, comparing equations (20) and (22) results in following equations:

δy₁=Vδy,

H_{X}_{₁}=VH_{X},

n₁=Vn.

It should be noted that the MSCKF method needs to calculate the matrix V. However, the disclosed method does not calculate any extra matrices, therefore, it may result in reduced number of calculations compared to the MSCKF.

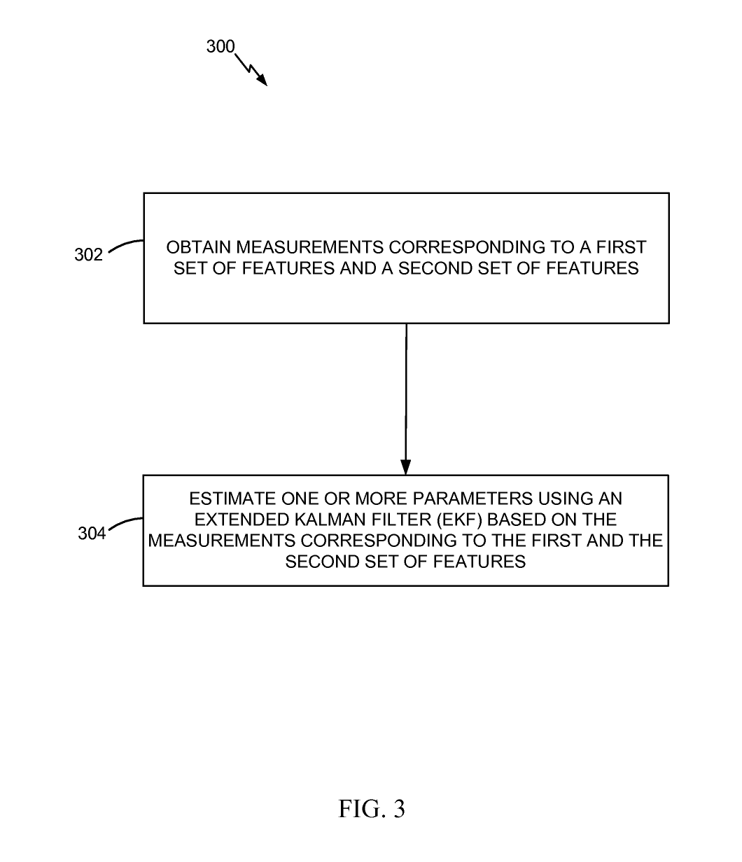

FIG. 3 illustrates example operations that may be performed to estimate one or more parameters (e.g., position) of a device, in accordance with certain embodiments of the present disclosure. At 302, the device may obtain measurements corresponding to a first set of features and a second set of features. For example, the device may include one or more sensors and obtain the measurements from its internal sensors. Alternatively, the device may receive measurements from another device. Yet, in another example, the device may perform some of the measurements itself, while receiving other measurements from other devices.

In one embodiment, the first set of features may be the in-state features and the second set of features may be the out-of-state features. At 304, the device may estimate the one or more parameters using an extended Kalman filter (EKF) while utilizing the measurements corresponding to the first set of features and the second set of features. The measurements corresponding to the first set of features may be used to update the parameter and information corresponding to the first set of features. The measurements corresponding to the second set of features may be used to update the parameter and an uncertainty corresponding to the parameter. In one embodiment, information corresponding to the second set of features is not updated during estimation. In one embodiment, the parameters are estimated without projecting the information corresponding to the second set of features into a null-space. In general, null-space projection refers to multiplying a matrix with a second matrix, when the result of multiplication is equal to zero.

As an example, the measurements corresponding to the first set of features are used during calculation of EKF update to the state parameter of the mobile device and 3D feature locations. The measurements corresponding to the second set of features are used during EKF update exclusively to update the mobile device parameters. In addition, the calculations related to computing the 3D location and uncertainty of out-of-state features are ignored. Therefore, the measurements corresponding to the first set of features may be used to update mobile device parameters, the 3D feature locations along with the full covariance matrix. On the other hand, the measurements corresponding to the second set of features may be used to update the estimate and uncertainty of the state parameters of the mobile device (e.g., navigational parameters).

In one embodiment, the first set of features may include a plurality of features that are tracked for at least a first time duration and the second set of features may include one or more features that are tracked for at least a second time duration. In one embodiment, the second time duration can be much smaller than the first time duration.

In one embodiment, the estimated position may be used to generate a map of the environment. In another embodiment, number of features in the second set of features is larger than the number of features in the first set of features. As an example, in order to reduce computational load of the device, only a few of the feature points may be used as in-state features and as many feature points as preferred may be used as out-of-state feature points. In one embodiment, the feature points may correspond to navigational parameters of the device, location of reference points in the neighborhood, information received from sensors, and the like.

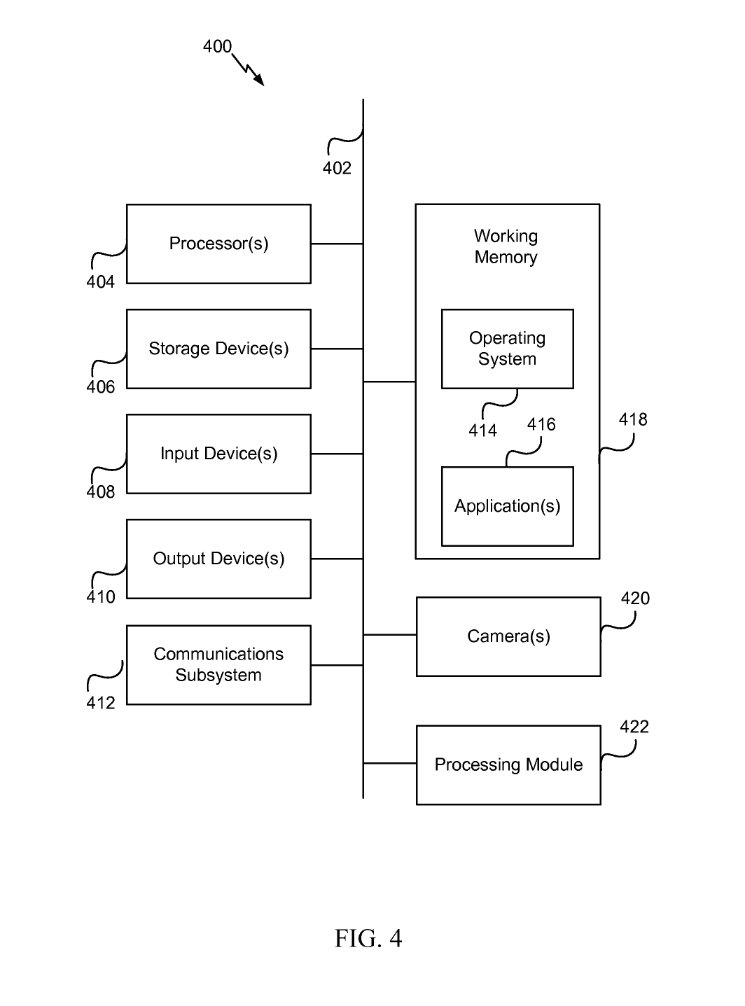

FIG. 4 describes one potential implementation of a device 400 which may be used to estimate a parameter (e.g., position of the device), according to certain embodiments. In one embodiment, device 400 may be implemented with the specifically described details of process 300. In the embodiment of device 400, specialized modules such as camera 420 and image processing module 422 may include functionality needed to capture and process information corresponding to feature points. For example, a camera may be used to capture images from the environment. The camera 420 and image processing modules 422 may be implemented to interact with various other modules of device 400. For example, the estimated parameter (e.g., position of a device) may be output on display output. In addition, the image processing module may be controlled via user inputs from user input module. User input module may accept inputs to define a user preferences regarding the estimation. Memory 418 may be configured to store information, and may also store settings and instructions that determine how the device operates.

In the embodiment shown at FIG. 4, the device may be a mobile device and include processor 404 configured to execute instructions for performing operations at a number of components and can be, for example, a general-purpose processor or microprocessor suitable for implementation within a portable electronic device. Processor 404 may thus implement any or all of the specific steps for operating a camera and image processing module as described herein. Processor 404 is communicatively coupled with a plurality of components within mobile device 400. To realize this communicative coupling, processor 404 may communicate with the other illustrated components across a bus 402. Bus 402 can be any subsystem adapted to transfer data within mobile device 400. Bus 402 can be a plurality of computer buses and include additional circuitry to transfer data.

Memory 418 may be coupled to processor 404. In some embodiments, memory 418 offers both short-term and long-term storage and may in fact be divided into several units. Short term memory may store images which may be discarded after an analysis, or all images may be stored in long term storage depending on user selections. Memory 418 may be volatile, such as static random access memory (SRAM) and/or dynamic random access memory (DRAM) and/or non-volatile, such as read-only memory (ROM), flash memory, and the like. Furthermore, memory 418 can include removable storage devices, such as secure digital (SD) cards. Thus, memory 418 provides storage of computer readable instructions, data structures, program modules, and other data for mobile device 400. In some embodiments, memory 418 may be distributed into different hardware modules.

In some embodiments, memory 418 stores a plurality of applications 416. Applications 416 contain particular instructions to be executed by processor 404. In alternative embodiments, other hardware modules may additionally execute certain applications or parts of applications. Memory 418 may be used to store computer readable instructions for modules that implement scanning according to certain embodiments, and may also store compact object representations as part of a database.

In some embodiments, memory 418 includes an operating system 414. Operating system 414 may be operable to initiate the execution of the instructions provided by application modules and/or manage other hardware modules as well as interfaces with communication modules which may use wireless transceiver 412. Operating system 414 may be adapted to perform other operations across the components of mobile device 400, including threading, resource management, data storage control and other similar functionality.

In some embodiments, mobile device 400 includes a plurality of other hardware modules. Each of the other hardware modules is a physical module within mobile device 400. However, while each of the hardware modules is permanently configured as a structure, a respective one of hardware modules may be temporarily configured to perform specific functions or temporarily activated.

Other embodiments may include sensors integrated into device 400. an example of a sensor can be, for example, an accelerometer, a wi-fi transceiver, a satellite navigation system receiver (e.g., a GPS module), a pressure module, a temperature module, an audio output and/or input module (e.g., a microphone), a camera module, a proximity sensor, an alternate line service (ALS) module, a capacitive touch sensor, a near field communication (NFC) module, a Bluetooth transceiver, a cellular transceiver, a magnetometer, a gyroscope, an inertial sensor (e.g., a module the combines an accelerometer and a gyroscope), an ambient light sensor, a relative humidity sensor, or any other similar module operable to provide sensory output and/or receive sensory input. In some embodiments, one or more functions of the sensors may be implemented as hardware, software, or firmware. Further, as described herein, certain hardware modules such as the accelerometer, the GPS module, the gyroscope, the inertial sensor, or other such modules may be used in conjunction with the camera and image processing module to provide additional information. In certain embodiments, a user may use a user input module 408 to select how to analyze the images.

Mobile device 400 may include a component such as a wireless communication module which may integrate antenna and wireless transceiver 412 with any other hardware, firmware, or software necessary for wireless communications. Such a wireless communication module may be configured to receive signals from various devices such as data sources via networks and access points such as a network access point. In certain embodiments, compact object representations may be communicated to server computers, other mobile devices, or other networked computing devices to be stored in a remote database and used by multiple other devices when the devices execute object recognition functionality

In addition to other hardware modules and applications in memory 418, mobile device 400 may have a display output 410 and a user input module 408. Display output graphically presents information from mobile device 400 to the user. This information may be derived from one or more application modules, one or more hardware modules, a combination thereof, or any other suitable means for resolving graphical content for the user (e.g., by operating system 414). Display output 410 can be liquid crystal display (LCD) technology, light emitting polymer display (LPD) technology, or some other display technology. In some embodiments, display module is a capacitive or resistive touch screen and may be sensitive to haptic and/or tactile contact with a user. In such embodiments, the display output can comprise a multi-touch-sensitive display. Display output may then be used to display any number of outputs associated with a camera 420 or image processing module 422, such as alerts, settings, thresholds, user interfaces, or other such controls.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner.

Specific details are given in the description to provide a thorough understanding of the embodiments. However, embodiments may be practiced without certain specific details. For example, well-known circuits, processes, algorithms, structures, and techniques have been mentioned without unnecessary detail in order to avoid obscuring the embodiments. This description provides example embodiments only, and is not intended to limit the scope, applicability, or configuration of various embodiments. Rather, the preceding description of the embodiments will provide those skilled in the art with an enabling description for implementing embodiments. Various changes may be made in the function and arrangement of elements without departing from the spirit and scope of various embodiments.

Also, some embodiments were described as processes which may be depicted in a flow with process arrows. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks. Additionally, the above elements may merely be a component of a larger system, wherein other rules may take precedence over or otherwise modify the application of various embodiments, and any number of steps may be undertaken before, during, or after the elements of any embodiment are implemented.

Having described several embodiments, it will therefore be clear to a person of ordinary skill that various modifications, alternative constructions, and equivalents may be used without departing from the spirit of the disclosure.

What is claimed is:

1. A method for estimating one or more parameters corresponding to a device, comprising:
obtaining measurements corresponding to a first set of features and a second set of features; and
estimating the one or more parameters using an extended Kalman filter (EKF) based on the measurements corresponding to the first set of features and the second set of features, wherein the measurements corresponding to the first set of features are used to update the one or more parameters, and information corresponding to the first set of features and the measurements corresponding to the second set of features are used to update the one or more parameters and uncertainty corresponding to the one or more parameter, wherein information corresponding to the second set of features is not updated during the estimating, and wherein the one or more parameters are estimated without projecting the information corresponding to the second set of features into a null-space.

2. The method of claim 1, wherein the first set of features comprises one or more features that are tracked for at least a first time duration and the second set of features comprises one or more features that are tracked for at least a second time duration, and wherein the second time duration is smaller than the first time duration.

3. The method of claim 1, wherein estimating the one or more parameters comprises:
estimating the one or more parameters using the EKF, wherein a variance value corresponding to information associated with each feature in the second set of features is artificially chosen to be a large number.

4. The method of claim 1, wherein the first plurality of measurements correspond to present values of one or more features in the first set of features, and the second plurality of measurements correspond to present or past values of one or more features in the second set of features.

5. The method of claim 1, wherein the one or more parameters correspond to position of the device and each feature in the first or second set of features corresponds to one or more parameters selected from a group consisting of navigational parameters, information corresponding to position of reference points in the neighborhood, and information received from sensors.

6. The method of claim 1, wherein the information corresponding to the first set of features comprises three-dimensional position of each feature in the first set of features.

7. The method of claim 1, wherein the one or more parameters correspond to one or more navigational parameter of the device.

8. The method of claim 1, wherein the one or more parameters correspond to a state vector X, wherein the state vector X is estimated as follows:
$${K}_{1} = {P}_{X} {H}_{X}^{T} {S}^{- 1} , \\ {A}_{+}^{} = {K}_{1} δ y , \\ {P}_{A}^{+} = ( I - {K}_{1} {H}_{A} ) {P}_{X} , \\ in which {H}_{A} = [ {H}_{X} {H}_{f} ] , \\ {P}_{A} = [ \begin{matrix}{P}_{x} & 0 \\ 0 & {P}_{f}\end{matrix} ] , \\ δ {X}_{A}^{T} = [ δ {X}^{T} δ {f}^{T} ] , \\ S = {H}_{A} {P}_{A} {H}_{A}^{T} + R , \\ δ y = {H}_{A} δ {X}_{A} + n , \\ {S}^{- 1} = [ \begin{matrix}{( I + {H}_{X} {P}_{X} {H}_{X}^{T} )}^{- 1} & 0 \\ 0 & 0\end{matrix} ] ,$$
wherein K₁ represents Kalman gain corresponding to the first set of features, y represents the measurements corresponding to the first and the second set of features, δX^{T} represents innovation of the state vector X and δf^{T} represents innovation of the second set of features f, S represents the innovation covariance matrix, P_{A} represents covariance of the error in the estimate of an augmented state vector X_{A}=[X f], H_{A} represents measurement Jacobian of the augmented state vector H_{A}=[H_{X} H_{f}], and n represents noise.

9. An apparatus for estimating one or more parameters corresponding to a device, comprising:
at least one processor configured to:
obtain measurements corresponding to a first set of features and a second set of features, and
estimate the one or more parameters using an extended Kalman filter (EKF) based on the measurements corresponding to the first set of features and the second set of features, wherein the measurements corresponding to the first set of features are used to update the one or more parameters, and information corresponding to the first set of features and the measurements corresponding to the second set of features are used to update the one or more parameters and uncertainty corresponding to the one or more parameter, wherein information corresponding to the second set of features is not updated during the estimating, and wherein the one or more parameters are estimated without projecting the information corresponding to the second set of features into a null-space; and
a memory coupled to the at least one processor.

10. The apparatus of claim 9, wherein the first set of features comprises one or more features that are tracked for at least a first time duration and the second set of features comprises one or more features that are tracked for at least a second time duration, and wherein the second time duration is smaller than the first time duration.

11. The apparatus of claim 9, wherein the at least one processor is further configured to:
estimate the one or more parameters using the EKF, wherein a variance value corresponding to information associated with each feature in the second set of features is artificially chosen to be a large number.

12. The apparatus of claim 9, wherein the first plurality of measurements correspond to present values of one or more features in the first set of features, and the second plurality of measurements correspond to present or past values of one or more features in the second set of features.

13. The apparatus of claim 9, wherein the one or more parameters correspond to position of the device and each feature in the first or second set of features corresponds to one or more parameters selected from a group consisting of navigational parameters, information corresponding to position of reference points in the neighborhood, and information received from sensors.

14. The apparatus of claim 9, wherein the information corresponding to the first set of features comprises three-dimensional position of each feature in the first set of features.

15. The apparatus of claim 9, wherein the one or more parameters correspond to one or more navigational parameter of the device.

16. The apparatus of claim 9, wherein the one or more parameters correspond to a state vector X, wherein the state vector X is estimated as follows:
$${K}_{1} = {P}_{X} {H}_{X}^{T} {S}^{- 1} , \\ {A}_{+}^{} = {K}_{1} δ y , \\ {P}_{A}^{+} = ( I - {K}_{1} {H}_{A} ) {P}_{X} , \\ in which {H}_{A} = [ {H}_{X} {H}_{f} ] , \\ {P}_{A} = [ \begin{matrix}{P}_{x} & 0 \\ 0 & {P}_{f}\end{matrix} ] , \\ δ {X}_{A}^{T} = [ δ {X}^{T} δ {f}^{T} ] , \\ S = {H}_{A} {P}_{A} {H}_{A}^{T} + R , \\ δ y = {H}_{A} δ {X}_{A} + n , \\ {S}^{- 1} = [ \begin{matrix}{( I + {H}_{X} {P}_{X} {H}_{X}^{T} )}^{- 1} & 0 \\ 0 & 0\end{matrix} ] ,$$
wherein K₁ represents Kalman gain corresponding to the first set of features, y represents the measurements corresponding to the first and the second set of features, δX^{T} represents innovation of the state vector X and δf^{T} represents innovation of the second set of features f, S represents the innovation covariance matrix, P_{A} represents covariance of the error in the estimate of an augmented state vector X_{A}=[X f], H_{A} represents measurement Jacobian of the augmented state vector H_{A}=[H_{X} H_{f}], and n represents noise.

17. An apparatus for estimating one or more parameters corresponding to a device, comprising:
means for obtaining measurements corresponding to a first set of features and a second set of features; and
means for estimating the one or more parameters using an extended Kalman filter (EKF) based on the measurements corresponding to the first set of features and the second set of features, wherein the measurements corresponding to the first set of features are used to update the one or more parameters, and information corresponding to the first set of features and the measurements corresponding to the second set of features are used to update the one or more parameters and uncertainty corresponding to the one or more parameter, wherein information corresponding to the second set of features is not updated during the estimating, and wherein the one or more parameters are estimated without projecting the information corresponding to the second set of features into a null-space.

18. The apparatus of claim 17, wherein the first set of features comprises one or more features that are tracked for at least a first time duration and the second set of features comprises one or more features that are tracked for at least a second time duration, and wherein the second time duration is smaller than the first time duration.

19. The apparatus of claim 17, wherein the means for estimating the one or more parameters comprises:
means for estimating the one or more parameters using the EKF, wherein a variance value corresponding to information associated with each feature in the second set of features is artificially chosen to be a large number.

20. The apparatus of claim 17, wherein the first plurality of measurements correspond to present values of one or more features in the first set of features, and the second plurality of measurements correspond to present or past values of one or more features in the second set of features.

21. The apparatus of claim 17, wherein the one or more parameters correspond to position of the device and each feature in the first or second set of features corresponds to one or more parameters selected from a group consisting of navigational parameters, information corresponding to position of reference points in the neighborhood, and information received from sensors.

22. The apparatus of claim 17, wherein the information corresponding to the first set of features comprises three-dimensional position of each feature in the first set of features.

23. The apparatus of claim 17, wherein the one or more parameters correspond to one or more navigational parameter of the device.

24. The apparatus of claim 17, wherein the one or more parameters correspond to a state vector X, wherein the state vector X is estimated as follows:
$${K}_{1} = {P}_{X} {H}_{X}^{T} {S}^{- 1} , \\ {A}_{+}^{} = {K}_{1} δ y , \\ {P}_{A}^{+} = ( I - {K}_{1} {H}_{A} ) {P}_{X} , \\ in which {H}_{A} = [ {H}_{X} {H}_{f} ] , \\ {P}_{A} = [ \begin{matrix}{P}_{x} & 0 \\ 0 & {P}_{f}\end{matrix} ] , \\ δ {X}_{A}^{T} = [ δ {X}^{T} δ {f}^{T} ] , \\ S = {H}_{A} {P}_{A} {H}_{A}^{T} + R , \\ δ y = {H}_{A} δ {X}_{A} + n , \\ {S}^{- 1} = [ \begin{matrix}{( I + {H}_{X} {P}_{X} {H}_{X}^{T} )}^{- 1} & 0 \\ 0 & 0\end{matrix} ] ,$$
wherein K₁ represents Kalman gain corresponding to the first set of features, y represents the measurements corresponding to the first and the second set of features, δX^{T} represents innovation of the state vector X and δf^{T} represents innovation of the second set of features f, S represents the innovation covariance matrix, P_{A} represents covariance of the error in the estimate of an augmented state vector X_{A}=[X f], H_{A} represents measurement Jacobian of the augmented state vector H_{A}=[H_{X} H_{f}], and n represents noise.

25. A non-transitory computer readable medium for estimating one or more parameters corresponding to a device, comprising computer-readable instructions configured to cause a processor to:
obtain measurements corresponding to a first set of features and a second set of features; and
estimate the one or more parameters using an extended Kalman filter (EKF) based on the measurements corresponding to the first set of features and the second set of features, wherein the measurements corresponding to the first set of features are used to update the one or more parameters, and information corresponding to the first set of features and the measurements corresponding to the second set of features are used to update the one or more parameters and uncertainty corresponding to the one or more parameter, wherein information corresponding to the second set of features is not updated during the estimating, and wherein the one or more parameters are estimated without projecting the information corresponding to the second set of features into a null-space.

26. The computer readable medium of claim 25, wherein the first set of features comprises one or more features that are tracked for at least a first time duration and the second set of features comprises one or more features that are tracked for at least a second time duration, and wherein the second time duration is smaller than the first time duration.

27. The computer readable medium of claim 25, wherein the first plurality of measurements correspond to present values of one or more features in the first set of features, and the second plurality of measurements correspond to present or past values of one or more features in the second set of features.

28. The computer readable medium of claim 25, wherein the one or more parameters correspond to position of the device and each feature in the first or second set of features corresponds to one or more parameters selected from a group consisting of navigational parameters, information corresponding to position of reference points in the neighborhood, and information received from sensors.

29. The computer readable medium of claim 25, wherein the information corresponding to the first set of features comprises three-dimensional position of each feature in the first set of features.

30. The computer readable medium of claim 25, wherein the one or more parameters correspond to a state vector X, wherein the state vector X is estimated as follows:
$${K}_{1} = {P}_{X} {H}_{X}^{T} {S}^{- 1} , \\ {A}_{+}^{} = {K}_{1} δ y , \\ {P}_{A}^{+} = ( I - {K}_{1} {H}_{A} ) {P}_{X} , \\ in which {H}_{A} = [ {H}_{X} {H}_{f} ] , \\ {P}_{A} = [ \begin{matrix}{P}_{x} & 0 \\ 0 & {P}_{f}\end{matrix} ] , \\ δ {X}_{A}^{T} = [ δ {X}^{T} δ {f}^{T} ] , \\ S = {H}_{A} {P}_{A} {H}_{A}^{T} + R , \\ δ y = {H}_{A} δ {X}_{A} + n , \\ {S}^{- 1} = [ \begin{matrix}{( I + {H}_{X} {P}_{X} {H}_{X}^{T} )}^{- 1} & 0 \\ 0 & 0\end{matrix} ] ,$$
wherein K₁ represents Kalman gain corresponding to the first set of features, y represents the measurements corresponding to the first and the second set of features, δX^{T} represents innovation of the state vector X and δf^{T} represents innovation of the second set of features f, S represents the innovation covariance matrix, P_{A} represents covariance of the error in the estimate of an augmented state vector X_{A}=[X f], H_{A} represents measurement Jacobian of the augmented state vector H_{A}=[H_{X} H_{f}], and n represents noise.
